(19) United States
(12) Patent Application Publication
(10) Pub. No.: US 2024/0354671 A1
(43) Pub. Date: Oct. 24, 2024

(54) INFORMATION PROCESSING APPARATUS, INFORMATION PROCESSING METHOD, AND INFORMATION PROCESSING PROGRAM

(71) Applicant: NIPPON TELEGRAPH AND TELEPHONE CORPORATION, Tokyo (JP)

(72) Inventors: Satoshi TAKATSU, Musashino-shi, Tokyo (JP); Tomoko SHIBATA, Musashino-shi, Tokyo (JP); Hiroshi YOSHIDA, Musashino-shi, Tokyo (JP); Masanobu SAKAMOTO, Musashino-shi, Tokyo (JP)

(73) Assignee: NIPPON TELEGRAPH AND TELEPHONE CORPORATION, Tokyo (JP)

(21) Appl. No.: 18/683,782

(22) PCT Filed: Aug. 17, 2021
(86) PCT No.: PCT/JP2021/030049

§ 371 Date: Feb. 15, 2024

(51) Int. Cl. G06Q 10/0631

(52) U.S. Cl. CPC G06Q 10/063112

(57) ABSTRACT

An information processing apparatus according to an embodiment includes an acquisition unit that acquires task attribute information including an allocation result indicating which worker among a plurality of workers has been allocated to a past task, and requirements necessary for the task, a number-of-handleable cases determination unit that calculates the number of tasks that are handleable in the worker on the basis of the allocation result, an allocation result sorting unit that sorts the allocation results on the basis of the number of handleable tasks, and a person attribute bit value calculation unit that calculates a person attribute bit value indicating what type of attribute each worker has, on the basis of the sorted allocation result and the acquired task attribute.

### TECHNICAL FIELD

The present invention relates to an information processing apparatus, an information processing method, and an information processing program.

### BACKGROUND ART

In person resource allocation for allocating workers to a task, an allocation table may be created. It is necessary to consider various items when creating an allocation table due to the nature of allocating workers.

In recent years, in order to support creation of an allocation table, a technology for quantifying items such as worker skills or automating creation of an allocation table using a solver or the like using the same has been proposed. For example, PTL 1 discloses a technology for correctly obtaining information according to processing ability of a worker in charge of work.

### Citation List

### Patent Literature

[PTL 1] International Publication No. 2021-064881

### SUMMARY OF INVENTION

### Technical Problem

However, since person attribute information for indicating, for example, skills required for a worker (person) to perform a task changes as the person performs the task, an allocator or the like is required to perform an update task. For example, the person attribute information is updated through a skill test that is performed periodically (for example, once every six months). However, since actual person attribute information of a person is updated by performing a task on a daily basis, there is a problem that a difference between an actual skill or the like of the person and the person attribute information is caused until the person attribute information is updated, and the person attribute information rapidly becomes obsolete.

Further, when the person attribute information is automatically created from the allocation result, which is a past allocation table, an influence of a daily business situation is not taken into account, and thus there is a problem that an allocation result with low reliability, such as an allocation result including a task allocated to a person with an insufficient skill, an allocation result including overwork due to lack of people, or an allocation result created without thought from an allocator or the like, is reflected in the person attribute information.

The subject of the present invention is based on the above circumstances and an object thereof is to provide a technology for automatically and appropriately determining person attribute information without using a skill test or the like even amid changes in a daily business situation, a skill of a person, and the like.

### Solution to Problem

To solve the above problems, an aspect of the present invention is an information processing apparatus including an acquisition unit configured to acquire task attribute information including an allocation result indicating to which worker among a plurality of workers a past task has been allocated, and requirements necessary for the task; a number-of-handleable-cases determination unit configured to calculate the number of tasks that are handleable in each of the workers on the basis of the allocation result; an allocation result sorting unit configured to sort the allocation results on the basis of the number of handleable tasks; and a person attribute bit value calculation unit configured to calculate a person attribute bit value indicating what type of attribute each worker has, on the basis of the sorted allocation result and the acquired task attribute information.

### Advantageous Effects of Invention

According to an aspect of the present invention, it is possible to provide a technology for automatically and appropriately determining person attribute information without using a skill test or the like even amid changes in a daily business situation, a skill of a person, and the like.

### BRIEF DESCRIPTION OF DRAWINGS

FIG. 1 is a block diagram illustrating an example of a hardware configuration of an information processing apparatus according to a first embodiment.

FIG. 2 is a block diagram illustrating a software configuration of the information processing apparatus according to the first embodiment in association with the hardware configuration illustrated in FIG. 1.

FIG. 3 is a flowchart illustrating an example of an information processing operation of the information processing apparatus.

FIG. 4 is a diagram illustrating an example of allocation results.

FIG. 5 is a diagram illustrating an example of task attribute information.

FIG. 6 is a diagram illustrating an example of a totaling result of totaling the number of tasks for each person.

FIG. 7 is a diagram illustrating an example of task attribute information.

FIG. 8 is a diagram illustrating an example of person attribute bit values.

FIG. 9 is a flowchart illustrating an example of an information processing operation of the information processing apparatus according to a second embodiment.

FIG. 10 is a diagram illustrating an example of task attribute information.

FIG. 11 is a diagram illustrating an example of person attribute bit values.

FIG. 12 is a block diagram illustrating a software configuration of the information processing apparatus according to a third embodiment in association with the hardware configuration illustrated in FIG. 1.

FIG. 13 is a flowchart illustrating an example of an information processing operation of the information processing apparatus.

FIG. 14 is a diagram illustrating an example of forgetting curve information.

FIG. 15 is a diagram illustrating a period during which no attribute information is allocated to person 1 and a memory retention rate corresponding to this period.

FIG. 16 is a diagram illustrating an example of a corrected bit value.

FIG. 17 is a block diagram illustrating a software configuration of an information processing apparatus according to a fourth embodiment in association with the hardware configuration illustrated in FIG. 1.

FIG. 18 is a flowchart illustrating an example of an information processing operation of the information processing apparatus.

FIG. 19 is a diagram illustrating an example of productivity in past allocation results on a certain day.

FIG. 20 is a diagram illustrating an example of reference productivity.

FIG. 21 is a diagram illustrating an example of an average value of person attribute bit values for person 2 acquired from a person attribute bit value calculation unit.

FIG. 22 is a diagram illustrating a person attribute bit value before correction and a person attribute bit value after correction.

FIG. 23 is a block diagram illustrating a software configuration of the information processing apparatus according to a fifth embodiment in association with the hardware configuration illustrated in FIG. 1.

FIG. 24 is a flowchart illustrating an example of an information processing operation of the information processing apparatus

FIG. 25 is a diagram illustrating allocation results and task attribute bit values.

FIG. 26 is a diagram illustrating an example of the total number of bit values of each person calculated for each allocation result.

FIG. 27 illustrates an example in which a sorting result of each person has been added to the person attribute bit value.

### DESCRIPTION OF EMBODIMENTS

Hereinafter, embodiments according to the present invention will be described with reference to the drawings. Elements that are the same as or similar to elements that have already been described are denoted by the same or similar reference signs, and overlapping description is basically omitted.

### First Embodiment

### (Configuration)

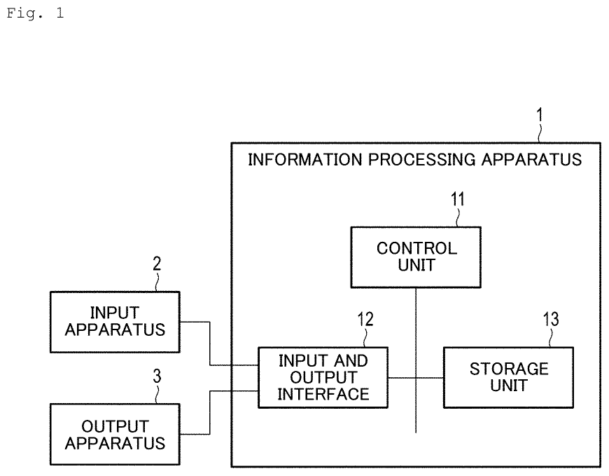

FIG. 1 is a block diagram illustrating an example of a hardware configuration of an information processing apparatus 1 according to the first embodiment.

The information processing apparatus 1 is realized by a computer such as a personal computer (PC). The information processing apparatus 1 includes a control unit 11, an input and output interface 12, and a storage unit 13. The control unit 11, the input and output interface 12, and the storage unit 13 are communicatively connected to each other via a bus.

The control unit 11 controls the information processing apparatus 1. The control unit 11 includes a hardware processor such as a central processing unit (CPU).

The input and output interface 12 is an interface that allows information to be transmitted and received between the input apparatus 2 and the output apparatus 3. The input and output interface 12 may include a wired or wireless communication interface. That is, the information processing apparatus 1, the input apparatus 2, and the output apparatus 3 may transmit and receive information via a network such as a LAN or the Internet.

The storage unit 13 is a storage medium. The storage unit 13 includes, for example, a combination of a nonvolatile memory such as a hard disk drive (HDD) or a solid state drive (SSD) on which writing and reading can performed at any time, a nonvolatile memory such as a read only memory (ROM), and a volatile memory such as a random access memory (RAM). The storage unit 13 has a program storage area and a data storage area in a storage area. The program storage area stores an operating system (OS), middleware, and an application program necessary for execution of various types of processing.

The input apparatus 2 includes, for example, a keyboard or a pointing device for a user of the information processing apparatus 1 (for example, an allocator, an administrator, or a supervisor) inputting instructions to the information processing apparatus 1. Further, the input apparatus 2 may include a reader for reading data to be stored in the storage unit 13 from a memory medium such as a USB memory, and a disk apparatus for reading such data from a disk medium. Further, the input apparatus 2 may include an image scanner.

The output apparatus 3 includes a display for displaying output data to be presented to the user from the information processing apparatus 1, a printer for printing the data, and the like. Further, the output apparatus 3 includes a writer for writing data to be input to another information processing apparatus 1 such as a PC or a smartphone to a memory medium such as a USB memory, or a disk apparatus for writing such data to a disk medium.

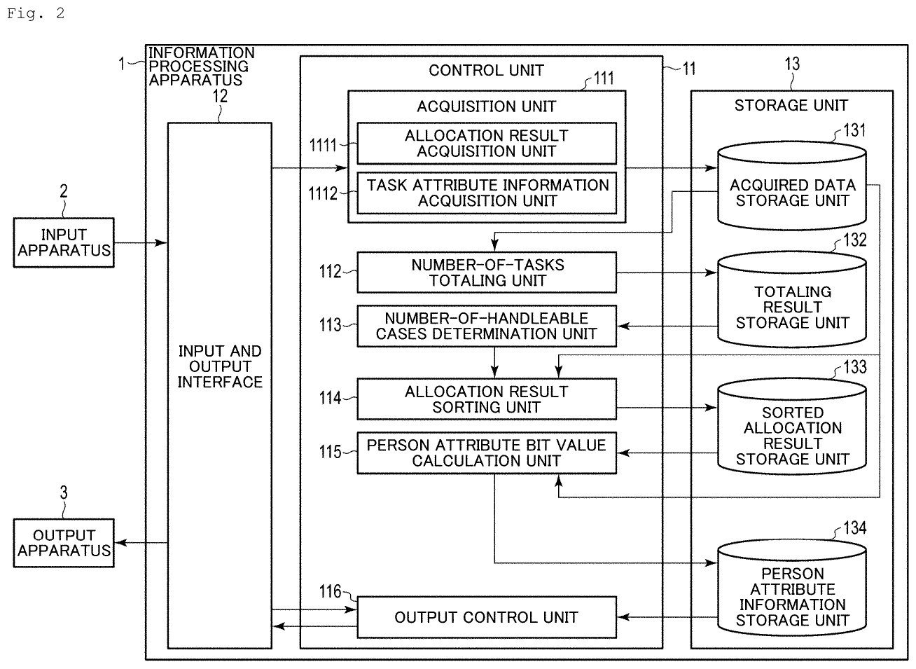

FIG. 2 is a block diagram illustrating a software configuration of the information processing apparatus 1 according to the first embodiment in association with the hardware configuration illustrated in FIG. 1

The storage unit 13 includes an acquired data storage unit 131, a totaling result storage unit 132, a sorted allocation result storage unit 133, and a person attribute information storage unit 134.

The acquired data storage unit 131 stores various types of data acquired by an acquisition unit 111 of the control unit 11, which will be described below. The data stored in the acquired data storage unit 131 includes the past allocation results, task attribute information, and the like. Each of the allocation result and the task attribute information may be acquired by capturing created data from the outside via the input apparatus 2, or may include data generated by the control unit 11. Further, the allocation result and the task attribute information will be described below.

The totaling result storage unit 132 stores information totaled by a number-of-tasks totaling unit 112 of the control unit 11, which will be described below.

The sorted allocation result storage unit 133 stores the allocation results sorted by an allocation result sorting unit 114 of the control unit 11, which will be described below.

The person attribute information storage unit 134 stores the person attribute information calculated by the person attribute bit value calculation unit 115 of the control unit 11, which will be described below.

The control unit 11 includes an acquisition unit 111, a number-of-tasks totaling unit 112, a number-of-handleable-cases determination unit 113, an allocation result sorting unit 114, a person attribute bit value calculation unit 115, and an output control unit 116. These functional units are realized by the hardware processor executing the application program stored in the storage unit 13.

The acquisition unit 111 acquires necessary data and stores the data in the acquired data storage unit 131. The acquisition unit 111 includes an allocation result acquisition unit 1111 and a task attribute information acquisition unit 1112.

The allocation result acquisition unit 1111 acquires an allocation result indicating to which worker a past task has been allocated. The allocation result indicates which task has been allocated to which person for a certain period during one day. For example, the allocation result indicates which task has been allocated to which person during morning, afternoon, and overtime, for example. The allocated period may be any period as long as the task can be performed. Further, the allocation result may be, for example, matrix data indicating which task person 1 has worked on in a certain period. The allocation result need not be manually input by the user, and may be created using a simulation or the like. Further, the allocation result acquisition unit 1111 may not acquire all past allocation results, and may acquire only allocation results that are not stored in the acquired data storage unit 131. Further, when the allocation result already stored in the acquired data storage unit 131 is acquired, the allocation result acquisition unit 1111 may ignore (discard) the allocation result.

The task attribute information acquisition unit 1112 acquires task attribute information including requirements necessary for the task. The attribute information of the task attribute information may be determined from the manual, requirements necessary for the task, and the like. For example, the attribute information of the task attribute information may include areas in which tasks are performed (for example, Shinjuku or Ikebukuro), a type of task (overhead power distribution line construction, road construction, or the like), a specific day of the week (a task on Saturday and Sunday), tools used for the task (for example, a bucket or ladder used for window cleaning), other attributes (for example, a task in an underground place), and the like. It is assumed that attribute information required for each task is represented by a bit value. For example, the bit value is expressed as “1” when there is attribute information required for the task, and expressed as “0” or blank when there is no attribute information. That is, the task attribute information acquisition unit 1112 can acquire matrix data indicating, by a bit value, whether task attribute information is required for a task.

The number-of-tasks totaling unit 112 totals how many tasks have been allocated to each person in one day on the basis of the allocation results. The number-of-tasks totaling unit 112 stores the totaling result in the totaling result storage unit 132.

The number-of-handleable-cases determination unit 113 determines the largest number of tasks from the totaling result stored in the totaling result storage unit 132. For example, when the largest number of tasks a person can handle in a day is two, the number-of-handleable-cases determination unit 113 determines that the number of tasks that the person can basically handle is two. The determined result is output to the allocation result sorting unit 114.

The allocation result sorting unit 114 sorts the allocation results into allocation results that fall within the number of basically handleable tasks and allocation results that do not fall within the number of basically handleable tasks on the basis of the number of basically handleable tasks in each person, which is received from number-of-handleable-cases determination unit 113, and the allocation results stored in the totaling result storage unit 132. The allocation result sorting unit 114 stores the allocation results that fall within the number of basically handleable tasks in the sorted allocation result storage unit 133.

The person attribute bit value calculation unit 115 calculates person attribute information on the basis of the allocation result stored the in sorted allocation result storage unit 133 and the task attribute information stored in acquired data storage unit 131. The calculation method will be described below. The person attribute bit value calculation unit 115 stores the calculated person attribute information in the person attribute information storage unit 134.

The output control unit 116 outputs the person attribute information stored in the person attribute information storage unit 134 to the output apparatus 3 via the input and output interface 12. The output control unit 116 may output the person attribute information stored in the person attribute information storage unit 134 according to an instruction from the input apparatus 2.

### (Operation)

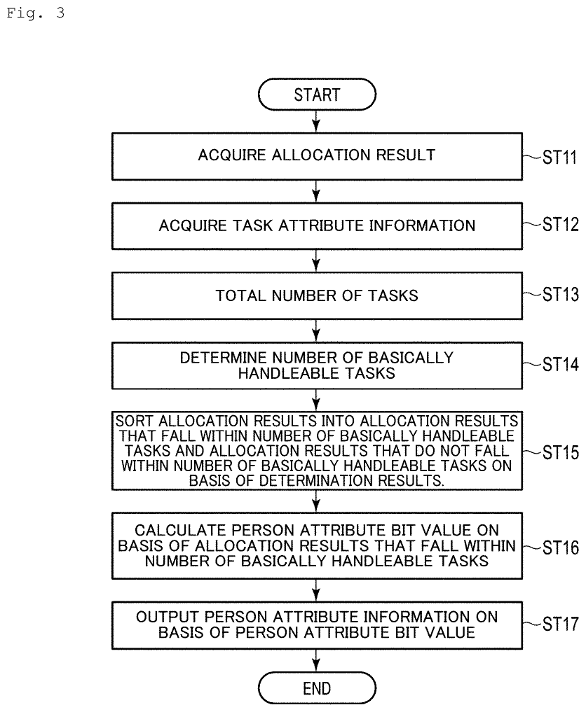

FIG. 3 is a flowchart illustrating an example of an information processing operation of the information processing apparatus 1. The control unit 11 of the information processing apparatus 1 reads and executes the program stored in the storage unit 13, thereby realizing the operation of this flowchart.

The operation starts when a user (for example, an administrator) of the information processing apparatus 1 inputs an instruction to output person attribute information to the information processing apparatus 1.

The allocation result acquisition unit 1111 of the information processing apparatus 1 acquires the allocation results via the input and output interface 12 (step ST11). The allocation result represents a result of allocating which worker to past task. The allocation result acquisition unit 1111 may acquire a plurality of allocation results (for example, 100 days). Here, the allocation result acquisition unit 1111 may acquire a result of the user inputting the actual past allocation result, or may acquire a result obtained by performing a simulation instead of the actual allocation result. The allocation result acquisition unit 1111 stores the acquired allocation result in the acquired data storage unit 131. The allocation result acquisition unit 1111 may not acquire all past allocation results, and may acquire only allocation results that are not stored in the acquired data storage unit 131. Further, when the allocation result already stored in the acquired data storage unit 131 is acquired, the allocation result acquisition unit 1111 may ignore (discard) the allocation result.

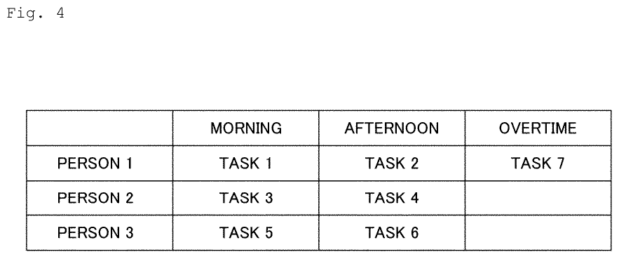

FIG. 4 is a diagram illustrating an example of the allocation results.

As illustrated in FIG. 4, the allocation results indicate which task has been allocated to a person during a certain period. For example, in the example illustrated in FIG. 4, the allocation results indicate that task 1 has been allocated to person 1 in the morning, task 2 in the afternoon, and task 7 in overtime. Similarly, the example illustrated in FIG. 4 shows that task 3 has been allocated in the morning and task 4 in the afternoon to person 2, and task 5 has been allocated in the morning and task 6 in the afternoon to person 3.

The task attribute information acquisition unit 1112 acquires task attribute information via the input and output interface 12 (step ST12). The task attribute information includes requirements necessary for the task. Here, the task attribute information acquisition unit 1112 may acquire a result of the user inputting the task attribute information. The task attribute information acquisition unit 1112 stores the acquired task attribute information in the acquired data storage unit 131. Further, step ST11 and step ST12 can be exchanged or may be performed at the same time.

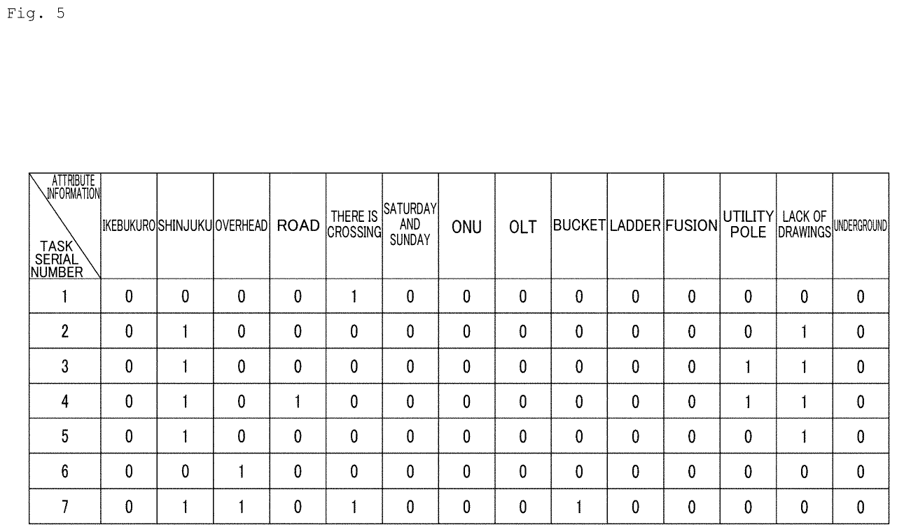

FIG. 5 is a diagram illustrating an example of the task attribute information.

As illustrated in FIG. 5, the task attribute information is represented by a bit value of “1” when each task requires attribute information, and represented by “0” when the task does not require the attribute information. For example, in the example illustrated in FIG. 5, tasks 1 to 7 are shown, and “Ikebukuro” and “Shinjuku” representing areas in which the tasks are performed, and “overhead (overhead power distribution construction)” and “roads (road construction)” representing types of constructions, “There is crossing (there is crossing of task work time)”, and “Saturday and Sunday (there is work on Saturday and Sunday)”, “optical network unit (ONU) (there is work about ONU)”, and “optical line terminal (OLT) (there is work about ONU)” representing times, “bucket (requires a bucket used for window cleaning)” and “ladder (a ladder is required)” representing tools required for a task, “fusion (there is fusion work)” and “utility pole (there is utility pole construction)” representing specific content of the task, and “lack of drawings (there is work with insufficient drawings)” and “underground (there is a task at an underground place)” representing other attribute information are shown. In the example illustrated in FIG. 5, task 2 is a task requires “Shinjuku” and “lack of drawings”.

The number-of-tasks totaling unit 112 totals the number of tasks (step ST13). The number-of-tasks totaling unit 112 acquires the allocation results stored in the acquired data storage unit 131. The number-of-tasks totaling unit 112 totals the number of tasks allocated to each person. For example, in the allocation result illustrated in FIG. 4, the number of tasks for person 1 is 3, and the number of tasks for person 2 and person 3 is 2. The number-of-tasks totaling unit 112 totals the number of allocation results stored in the totaling result storage unit 132 for each person. The number-of-tasks totaling unit 112 stores a result of the totaling in the totaling result storage unit 132.

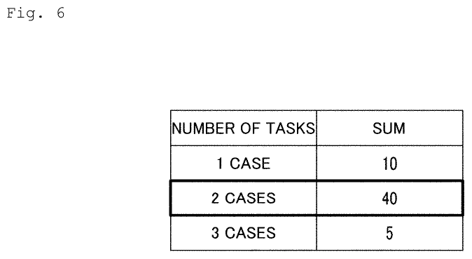

FIG. 6 is a diagram illustrating an example of a totaling result of totaling the number of tasks for each person. How many tasks corresponds according to the result of totaling the allocation results is illustrated in FIG. 6. For example, FIG. 6 illustrates a result of totaling the number of tasks for person 1. It is shown that, for person 1, a total number of tasks is 10 when the number of tasks is 1, the total is 40 when the number of tasks is 2, and the total is 5 when the number of tasks is 3.

The number-of-handleable cases determination unit 113 determines the number of basically handleable tasks (step ST14). The number-of-handleable cases determination unit 113 acquires the totaling result from the totaling result storage unit 132. The number-of-handleable cases determination unit 113 determines the number of basically handleable tasks for each person on the basis of the totaling result. For example, the number-of-handleable cases determination unit 113 determines the number of tasks with the highest total number to be the number of basically handleable tasks in the person. For example, in the case of the totaling result of person 1 illustrated in FIG. 6, a determination is made that the number of basically handleable tasks in person 1 is two. When the total numbers are the same, the number-of-handleable cases determination unit 113 determines that a smaller number of tasks is the number of basically handleable tasks in the person. This is because a determination can be made that the smaller number of tasks is allocated to the task with a room. The number-of-handleable cases determination unit 113 determines the number of basically handleable tasks in each person, and outputs a result of the determination to the allocation result sorting unit 114.

The allocation result sorting unit 114 sorts the allocation results into the allocation results that fall within the number of basically handleable tasks and the allocation results that do not fall within the number of basically handleable tasks, on the basis of the determination result (step ST15). The allocation result sorting unit 114 acquires the allocation results from the acquired data storage unit 131 and sorts the allocation results on the basis of the result received from the number-of-handleable cases determination unit 113. Specifically, the allocation result sorting unit 114 sorts the allocation results into the allocation result that falls within the number of basically handleable tasks and the allocation result that does not fall within the number of basically handleable tasks, for each person. The allocation result sorting unit 114 stores only the allocation results that fall within the number of basically handleable tasks in the sorted allocation result storage unit 133. This is based on the assumption that the allocation result that the number of tasks fall within the number of basically handleable tasks was a proposal with room for operation, that is, a task has been allocated to the person after the attribute information of the person such as a skill is considered. On the other hand, the allocation results that do not fall within the number of basically handleable tasks are excluded from the data because the attribute information of the person such as the skill of person cannot be considered.

The person attribute bit value calculation unit 115 calculates the person attribute bit value on the basis of the allocation results that fall within the number of basically handleable tasks (step ST16). The person attribute bit value calculation unit 115 acquires the sorted allocation results from the sorted allocation result storage unit 133, that is, the allocation results that fall within the number of basically handleable tasks. Further, the person attribute bit value calculation unit 115 acquires the task attribute information stored in acquired data storage unit 131. The person attribute bit value calculation unit 115 calculates an average value of the person attribute bit values in each attribute pieces of information for each allocation result using Equation 1 below.

Average value of person attribute bits in each attribute piece of information=(number of bits allocated from task attribute bit value)/(number of tasks allocated to each person) (Equation 1)

The person attribute bit value calculation unit 115 calculates an average value of the person attribute bit values for the allocation results acquired from the sorted allocation result storage unit 133 using Equation 1 above. The person attribute bit value calculation unit 115 divides the calculated result by the number of allocation results of sorting the sum of the average values. When this value is equal to or greater than 0.5, the person attribute bit value calculation unit 115 determines that the person attribute is “1”, and when this value is smaller than 0.5, the person attribute bit value calculation unit 115 determines that the person attribute is “0”.

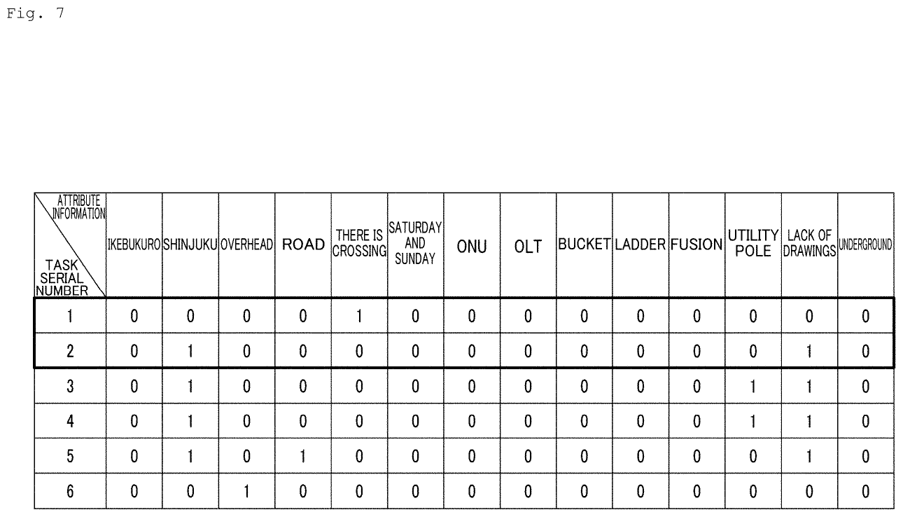

FIG. 7 is a diagram illustrating an example of the task attribute information.

As in FIG. 5, in the task attribute information, the bit value is expressed by “1” when each attribute corresponds to each task, and is expressed by “0” when each attribute does not correspond to the task. For example, referring to a certain allocation result, when person 1 is allocated to task 1 and task 2 (task 1 and task 2 surrounded by a thick frame in FIG. 7), an average value of person (person 1) attribute bit in each attribute information (Shinjuku) becomes ½=0.5 from (Equation 1). The person attribute bit value calculation unit 115 calculates the average value of the person attribute bits in each attribute piece of information for the sorted allocation result, and determines whether a value obtained by dividing the calculated total by the sorted allocation result is equal to or greater than “0.5”. The person attribute bit value calculation unit 115 sets that the person (for example, person 1) has the attribute information (for example, Shinjuku) for the attribute, that is, sets the bit value to “1” when the value is equal to or greater than “0.5”. The person attribute bit value calculation unit 115 stores the calculated person attribute bit value in the person attribute information storage unit 134.

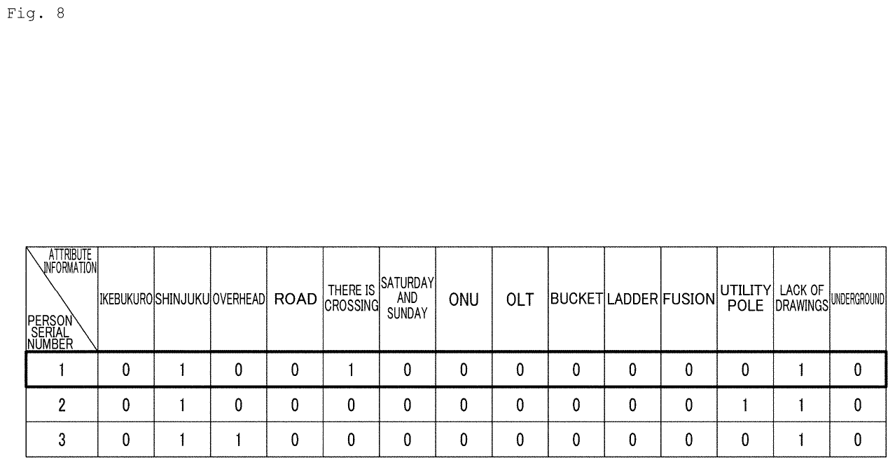

FIG. 8 is a diagram illustrating an example of the person attribute bit value.

As illustrated in FIG. 8, the person attribute bit value is information indicating what attribute information each person has, in a bit value. FIG. 8 illustrates an example of the result of performing the above-described calculation on each person (person 1, person 2, and person 3) to make a determination. As illustrated in FIG. 8, for person 1, a bit for Shinjuku, crossing, and lack of drawings in the attribute information is 1, that is, person 1 has attribute information for Shinjuku, crossing, and lack of drawings. Similarly, a bit for Shinjuku, utility pole, and lack of drawings is 1 for person 2, and a bit for Shinjuku, overhead, and lack of drawings is 1 for person 3, that is, person 2 has attribute information of Shinjuku, utility pole, and lack of drawings and person 3 has attribute information of Shinjuku, overhead, and lack of drawings.

The output control unit 116 outputs person attribute information on the basis of the person attribute bit value (step ST17). The output control unit 116 acquires the person attribute bit value stored in the person attribute information storage unit 134. The output control unit 116 outputs person attribute information on the basis of the acquired person attribute bit value. As illustrated in FIG. 8, a person attribute bit value may simply be output, or only attribute information possessed by each person may be output.

### (Effects)

According to the first embodiment, it is possible to determine the attribute information of the person without using a skill test or the like even when a daily business situation, a person skill, or the like is changing.

The accuracy of a proposal for allocating work to people created using a solver is improved by creating the person attribute information using only allocation results that can be estimated to have room for work.

Further, since it is possible to update the person attribute information from the past allocation results, the person attribute information is always updated by creating the person attribute information for past allocation results including a directly previous allocation result.

Further, when an administrator or the like creates the person attribute information, the person attribute information is characterized as related to people, and thus, it becomes possible to not only reduce a work burden on the administrator or the like, but also reduce a psychological burden by automating the work.

### Second Embodiment

When the number of the past allocation results is small (for example, 10 proposals or less), the allocation results that do not fall within the number of basically handleable tasks can also be valuable data. Therefore, the information processing apparatus 1 of the second embodiment outputs the person attribute information by utilizing the allocation results that do not fall within the number of tasks not considered in the first embodiment.

### (Configuration)

Since a hardware configuration and a software configuration of the information processing apparatus 1 according to the second embodiment are the same as those of the first embodiment, descriptions thereof will be omitted.

As in the first embodiment, the allocation result sorting unit 114 performs sorting into allocation results that fall within the number of basically handleable tasks and allocation results that do not fall within the number of basically handleable tasks among the allocation results stored in the acquired data storage unit 131 on the basis of the number of basically handleable tasks in each person, which has been received from the number-of-handleable cases determination unit 113. In the present embodiment, the allocation result sorting unit 114 stores the allocation results that do not fall within the number of basically handleable tasks, in addition to the allocation results that fall within the number of basically handleable tasks, in the sorted allocation result storage unit 133.

### (Operation)

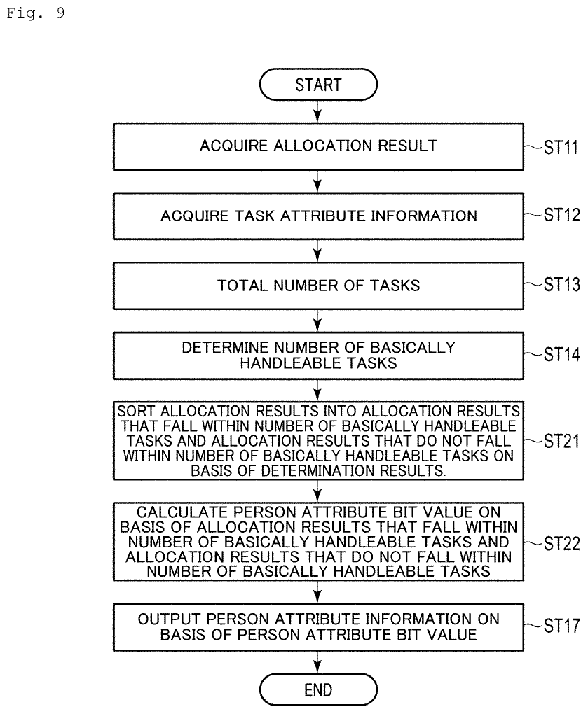

FIG. 9 is a flowchart illustrating an example of an information processing operation of the information processing apparatus 1. The control unit 11 of the information processing apparatus 1 reads and executes the program stored in the storage unit 13, thereby realizing the operation of this flowchart.

The operation starts when the user of the information processing apparatus 1 inputs predetermined information to the information processing apparatus 1.

Since steps ST11 to ST14 illustrated in FIG. 9 are the same as steps ST11 to ST14 described with reference to FIG. 3, re-descriptions thereof will be omitted.

It is assumed that the number of allocation results obtained in step ST11 is smaller than that in the first embodiment (for example, 10 proposals).

The allocation result sorting unit 114 performs sorting into the allocation results that fall within the number of basically handleable tasks and the allocation results that do not fall within the number of basically handleable tasks, on the basis of the determination results received from the number-of-handleable cases determination unit 113 (step ST21). The allocation result sorting unit 114 acquires the allocation results from the acquired data storage unit 131 and sorts the allocation results on the basis of the result received from the number-of-handleable cases determination unit 113. Specifically, the allocation result sorting unit 114 performs, for each person, sorting into the allocation result that falls within the number of basically handleable tasks and the allocation result that does not fall within the number of basically handleable tasks. The allocation result sorting unit 114 stores both the allocation results that fall within the number of basically handleable tasks and the allocation results that do not fall within the number of basically handleable tasks, in the sorted allocation result storage unit 133. This is an effective means, for example, when there are few allocation results input in step ST11. That is, the information processing apparatus 1 assumes that the allocation results that do not fall within the number of basically handleable tasks are also information useful for use in calculating the person attribute information. Therefore, the allocation result sorting unit 114 stores the allocation results that do not fall within the number of basically handleable tasks, in the sorted allocation result storage unit 133, in addition to the allocation result that the number of tasks falls within the number of basically handleable tasks.

The person attribute bit value calculation unit 115 calculates person attribute bit values on the basis of the allocation results that fall within the number of basically handleable tasks and the allocation results that do not fall within the number of basically handleable tasks (step ST22). First, person attribute bit value calculation unit 115 acquires, from the sorted allocation result storage unit 133, the sorted allocation results that fall within the number of basically handleable tasks. Further, the person attribute bit value calculation unit 115 acquires the task attribute information stored in acquired data storage unit 131. The person attribute bit value calculation unit 115 calculates the average value of the person attribute bit values in each attribute pieces of information using Equation 1 described in the first embodiment.

Next, person attribute bit value calculation unit 115 acquires, from the sorted allocation result storage unit 133, the sorted allocation results that do not fall within the number of basically handleable tasks. The person attribute bit value in each attribute pieces of information is calculated on the basis of Equation 2 below.

Average value of the person attribute bits in each attribute piece of information=(number of allocated bits from task attribute bit value)/(number of tasks allocated to each person)*(the number of basically handleable tasks)/(maximum number of tasks) (Equation 2)

Equation 2 is obtained by multiplying Equation 1 by (the number of basically handleable tasks/maximum number of tasks) on the assumption that allocation results that do not fall within the number of basically handleable tasks have a high risk of accidents or the like regardless of the number of tasks allocated to the person and are difficult to accumulate experience. For example, when the number of basically handleable tasks is 2, and the number of allocated tasks indicated by the allocation results is 3, such as person 1 illustrated in FIG. 4, Equation 2 above will be used.

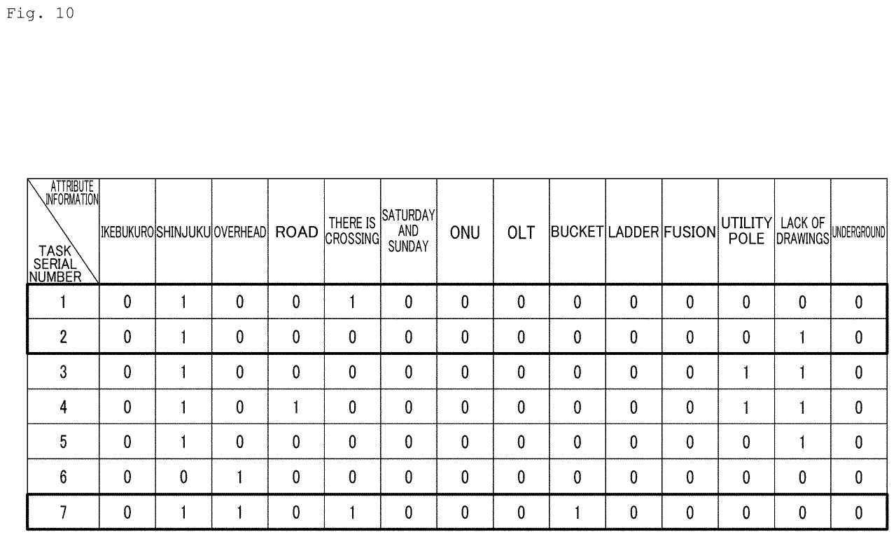

FIG. 10 is a diagram illustrating an example of task attribute information.

When the task attribute information of the task allocated to person 1 is illustrated in FIG. 5, an average value of Equation 2 above takes into consideration the task attribute information within a thick frame illustrated in FIG. 10. For example, when the average value is calculated for there being crossing of the attribute information, the person attribute bit value calculation unit 115 calculates (⅔)*(⅔)=0.44 and the average value.

The person attribute bit value calculation unit 115 calculates the above average value for each proposal for the sorted allocation results that fall within the number of basically handleable tasks and the sorted allocation results that do not fall within the number of basically handleable tasks, and divides the calculated average value by the number of input allocation results. When this value is equal to or greater than 0.5, the person attribute bit value calculation unit 115 determines that the person attribute is “1”, and when the value is smaller than 0.5, the person attribute bit value calculation unit 115 determines that the person attribute is “0”. For example, when the allocation results of two proposals are input, a first proposal falls within the number of basically handleable tasks, and the average value of the attribute information is 0.5, the second proposal does not fall within the number of basically handleable tasks, and the average value of the attribute information is 0.44, the person attribute bit value calculation unit 115 calculates (0.5+0.44)/2=0.47, and thus, a determination is made that the attribute information of the person is “0”.

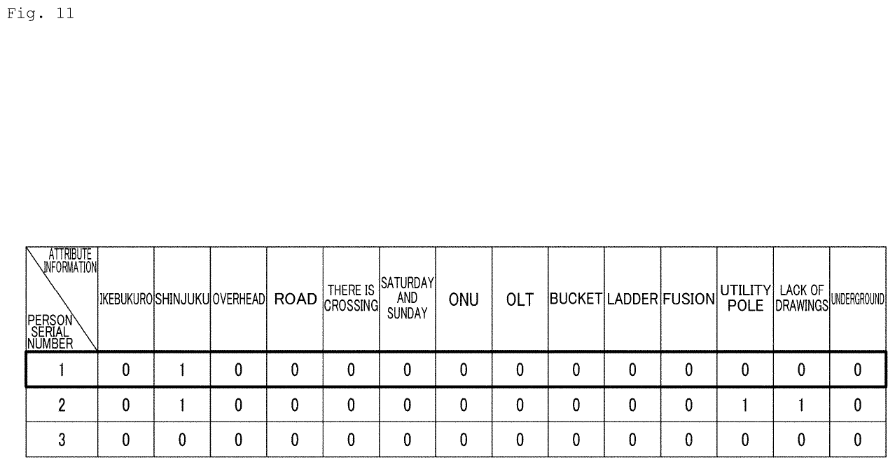

FIG. 11 is a diagram illustrating an example of person attribute bit values.

FIG. 11 illustrates an example of the result of performing the above-described calculation on each person (person 1, person 2, and person 3) to make a determination. As illustrated in FIG. 11, for person 1, the bit value of Shinjuku in the attribute information is 1, that is, person 1 has attribute information for Shinjuku. Similarly, for person 2, the bit values of Shinjuku, utility pole, and lack of drawings are 1, and for person 3, there is no attribute information with a bit value of 1.

The output control unit 116 outputs the person attribute information on the basis of the person attribute bit value (step ST17). The output control unit 116 acquires the person attribute bit value stored in the person attribute information storage unit 134. The output control unit 116 outputs person attribute information on the basis of the acquired person attribute bit value. As illustrated in FIG. 11, a person attribute bit value may simply be output, or only attribute information possessed by each person may be output. The output control unit 116 may output information indicating that the allocation result that does not fall within the number of basically handleable tasks has also been used.

Further, the first embodiment and the second embodiment may be operated in combination. For example, the control unit 11 may determine that the first embodiment is used when the allocation result input in step ST11 is equal to or greater than a predetermined threshold value (for example, 10 proposals), determine that the second embodiment is used when the allocation result is smaller than the predetermined threshold value, and execute the processing.

### (Effects)

According to the second embodiment, it is possible to determine the attribute information of the person without using a skill test or the like even when a daily business situation, a person skill, or the like is changing. According to the second embodiment, when the number of input allocation results in the past is small, it is possible to determine person attribute information by referring to allocation results that do not fall within the number of basically handleable tasks.

Further, since it is possible to update the person attribute information from the past allocation results, the person attribute information is always updated by creating the person attribute information for past allocation results including a directly previous allocation result.

Further, when an administrator or the like creates the person attribute information, the person attribute information is characterized as related to people, and thus, it becomes possible to not only reduce a work burden on the administrator or the like, but also reduce a psychological burden by automating the work.

### Third Embodiment

When a person has not performed a task for a while, the person will forget how to do the task. The administrator or the like needs to update the person attribute information in consideration of forgetting how to do this task. However, it is difficult to determine an update timing, because it is necessary to ascertain each person. Therefore, the information processing apparatus 1 of the third embodiment outputs the person attribute information in consideration of forgetting how to do a task.

### (Configuration)

Since a hardware configuration of the information processing apparatus 1 according to the third embodiment is the same as that of the first embodiment, description thereof is omitted.

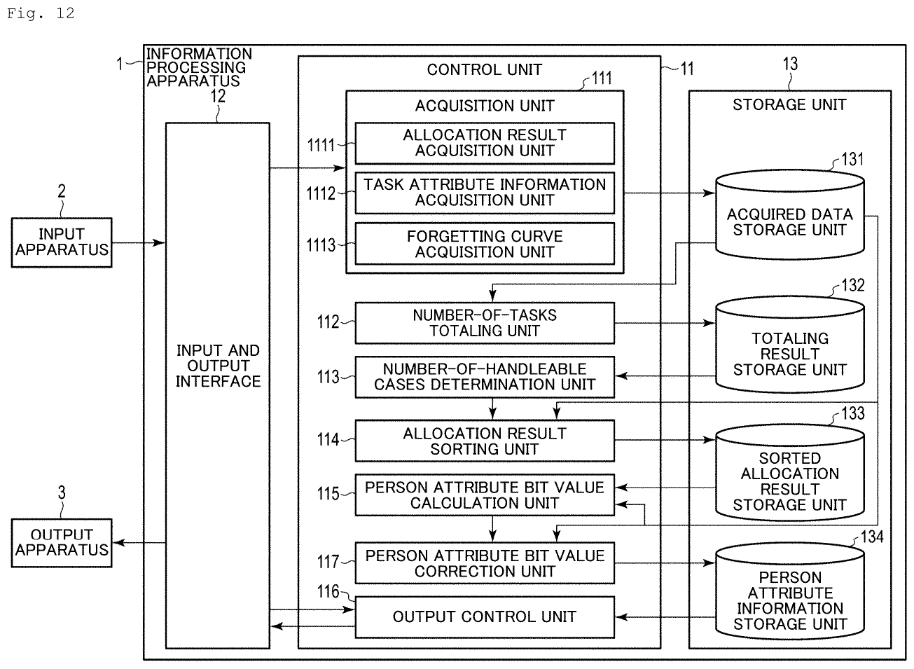

FIG. 12 is a block diagram illustrating a software configuration of the information processing apparatus 1 according to the third embodiment in association with the hardware configuration illustrated in FIG. 1.

A difference from the first embodiment is that the acquisition unit 111 has a forgetting curve acquisition unit 1113 and the control unit 11 includes a person attribute bit value correction unit 117.

The forgetting curve acquisition unit 1113 acquires forgetting curve information indicating how long a person can hold the skill of the same attribute information. The forgetting curve information is information including how much the task is remembered (memory retention rate) during a period until the task is newly allocated to a person from the last allocated task. The forgetting curve information may be input by a user or may be created using simulation. Further, the forgetting curve acquisition unit 1113 stores the forgetting curve information in the acquired data storage unit 131.

The person attribute bit value correction unit 117 corrects the person attribute information calculated by the person attribute bit value calculation unit 115 on the basis of the forgetting curve information. A correction method will be described below.

### (Operation)

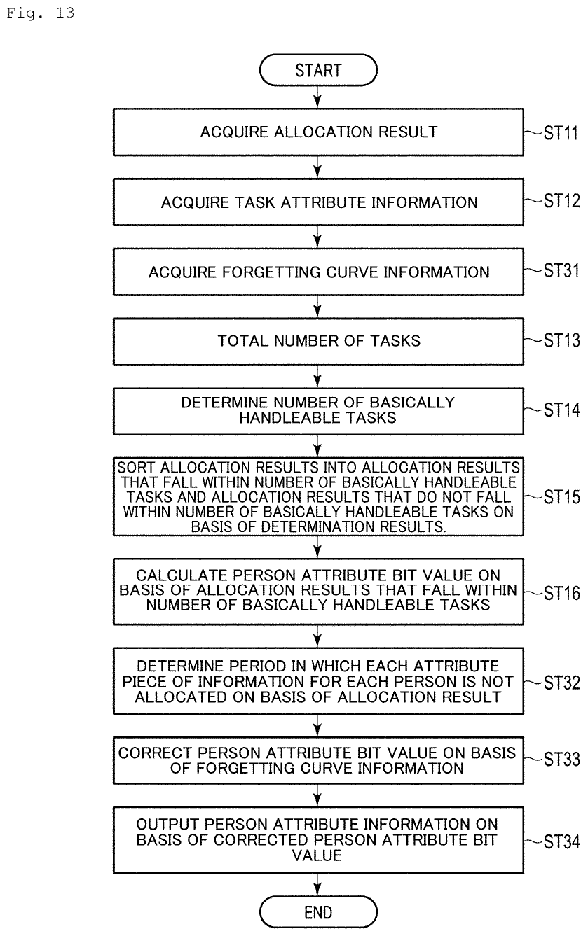

FIG. 13 is a flowchart illustrating an example of an information processing operation of the information processing apparatus 1. The control unit 11 of the information processing apparatus 1 reads and executes the program stored in the storage unit 13, thereby realizing the operation of this flowchart.

The operation starts when the user of the information processing apparatus 1 inputs predetermined information to the information processing apparatus 1.

Since steps ST11 to ST12 illustrated in FIG. 13 are the same as steps ST11 to ST12 described with reference to FIG. 3, re-descriptions thereof will be omitted.

The forgetting curve acquisition unit 1113 acquires the forgetting curve information (step ST31). The forgetting curve information is information including how much the task is remembered (memory retention rate) during a period until the task is newly allocated to a person from the last allocated task. That is, the forgetting curve information includes information indicating how much the worker remembers the task according to the number of days that have elapsed since the worker has performed the task. The forgetting curve acquisition unit 1113 stores the acquired allocation result in the acquired data storage unit 131.

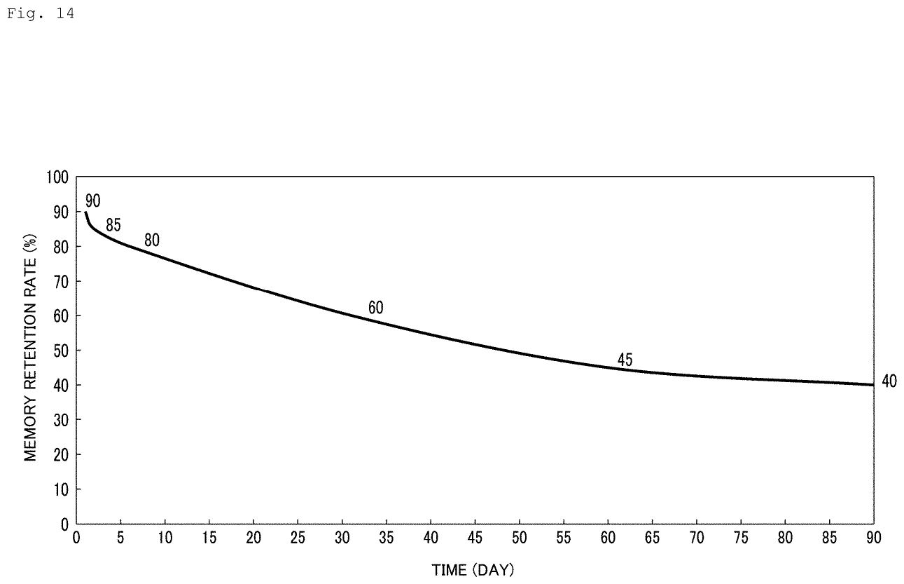

FIG. 14 is a diagram illustrating an example of the forgetting curve information.

In the forgetting curve information illustrated in FIG. 14, a horizontal axis indicates the number of days from last task execution to next allocation of the same task, and a vertical axis indicates the memory retention rate indicating how much the task is remembered. As illustrated in FIG. 14, when a task is not allocated for a long period of time, the person forgets about the task, and thus, the memory retention rate decreases. The forgetting curve information illustrated in FIG. 14 is merely an example, and is of course not limited to this forgetting curve.

Since steps ST13 to ST16 illustrated in FIG. 13 are the same as steps ST13 to ST16 described with reference to FIG. 3, re-descriptions thereof will be omitted.

In step ST16 in the third embodiment, the person attribute bit value calculation unit 115 does not store the calculated person attribute bit value in the person attribute information storage unit 134, but outputs the calculated person attribute bit value to the person attribute bit value correction unit 117.

The person attribute bit value correction unit 117 determines a period in which each attribute piece of information for each person is not allocated on the basis of the allocation result (step ST32). The person attribute bit value correction unit 117 acquires the allocation results from the acquired data storage unit 131. The person attribute bit value correction unit 117 determines how many days have passed since the last allocation date in the task of the allocation result in the attribute information in which the bit of each person is 1. The person attribute bit value correction unit 117 acquires a memory retention rate corresponding to the number of days elapsed from the forgetting curve information in each attribute pieces of information. Since the non-allocation days are all periods when each attribute pieces of information in the person is 0, the person attribute bit value correction unit 117 does not acquire the memory retention rate corresponding to the number of days elapsed from the forgetting curve.

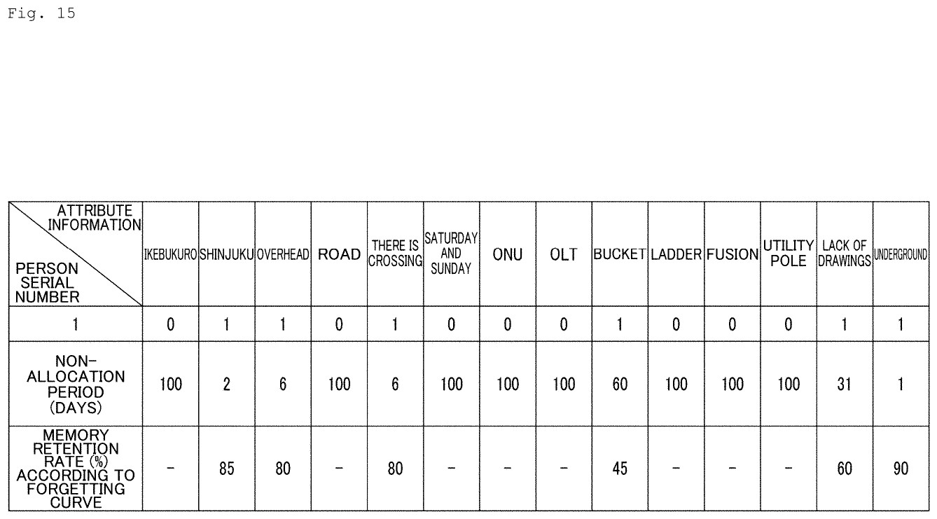

FIG. 15 is a diagram illustrating a period during which no attribute information is allocated to person 1 and a memory retention rate corresponding to this period. FIG. 15 illustrates an example in which the allocation result is 100 proposals (for 100 days). Referring to FIG. 15, for example, person 1 has been allocated a task including Shinjuku two days ago, and the memory retention rate in that case is 85%. Similarly, it is shown that person 1 has been allocated the task including the bucket 60 days ago, and that the memory retention rate in this case is 45%.

The person attribute bit value correction unit 117 corrects the person attribute bit value on the basis of the forgetting curve (step ST33). The person attribute bit value correction unit 117 regards the person as holding the storage of the attribute and sets the bit value to 1 when bit value*memory retention ratio is equal to or greater than 0.5, and regards the person as not holding the storage of the attribute and sets the bit value to 0 when bit value*memory retention ratio is smaller than 0.5.

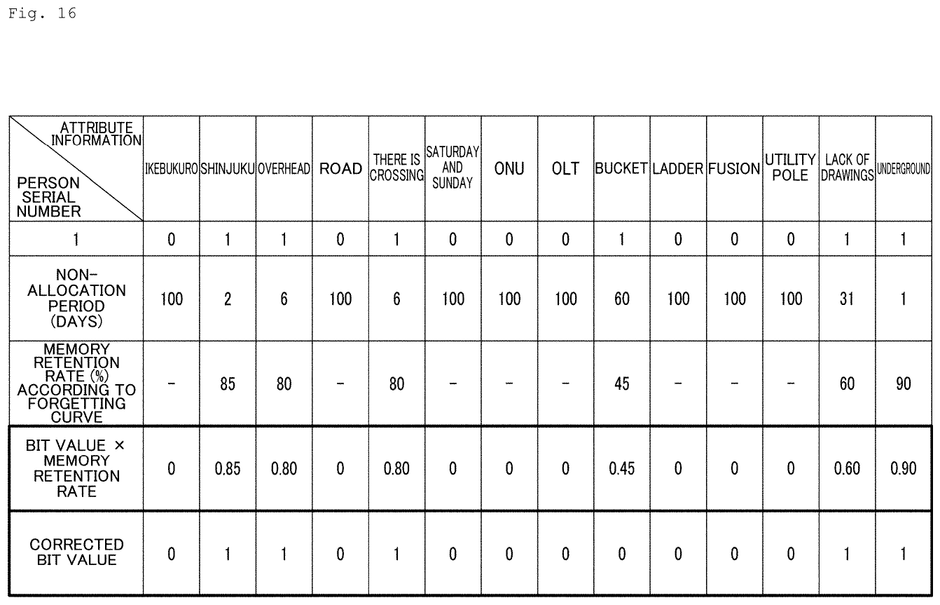

FIG. 16 is a diagram illustrating an example of the corrected bit values.

As illustrated in FIG. 16, in the bucket, bit value*memory retention rate=0.45 and is 0.5 or less. Therefore, the person attribute bit value correction unit 117 corrects the bit value of the bucket from 1 to 0. Further, since the bit value*memory retention rate is equal to or greater than 0.5 for other Shinjuku, overhead, there being crossing, lack of drawings, and underground, the person attribute bit value correction unit 117 leaves the bit value as 1. The person attribute bit value correction unit 117 stores the corrected person attribute information in the person attribute information storage unit 134.

The output control unit 116 outputs the person attribute information on the basis of the corrected person attribute bit value (step ST34). The output control unit 116 acquires the person attribute bit value stored in the person attribute information storage unit 134. The output control unit 116 outputs person attribute information on the basis of the acquired person attribute bit value. As illustrated in FIG. 8, a person attribute bit value may simply be output, or only attribute information possessed by each person may be output.

The third embodiment may be operated in combination with the second embodiment. For example, when the allocation result input in step ST11 is smaller than a predetermined threshold value (for example, 10 proposals), a determination may be made that the second embodiment is used, and processing may be executed.

### (Effects)

According to the third embodiment, it is possible to determine the attribute information of the person in consideration of a case in which the attribute information has not been used for a long period of time without using a skill test or the like.

The accuracy of the proposal for allocating tasks to people created using the solver is improved by creating the attribute information of the human using only the allocation results that have room for work.

Further, since it is possible to update the person attribute information from the past allocation results, the person attribute information is always updated by creating the person attribute information for past allocation results including a directly previous allocation result.

Further, when an administrator or the like creates the person attribute information, the person attribute information is characterized as related to people, and thus, it becomes possible to not only reduce a work burden on the administrator or the like, but also reduce a psychological burden by automating the work.

### Fourth Embodiment

people may not ensure sufficient productivity due to lack of experience. For example, even when a person who has a license but is a paper driver drives a vehicle, the user cannot reach a destination even after a predetermined time has passed. Therefore, the information processing apparatus 1 of the fourth embodiment outputs the person attribute information in consideration of an experience value of the person when determining the attribute information of the person.

### (Configuration)

Since a hardware configuration of the information processing apparatus 1 according to the fourth embodiment is the same as that of the first embodiment, description thereof will be omitted.

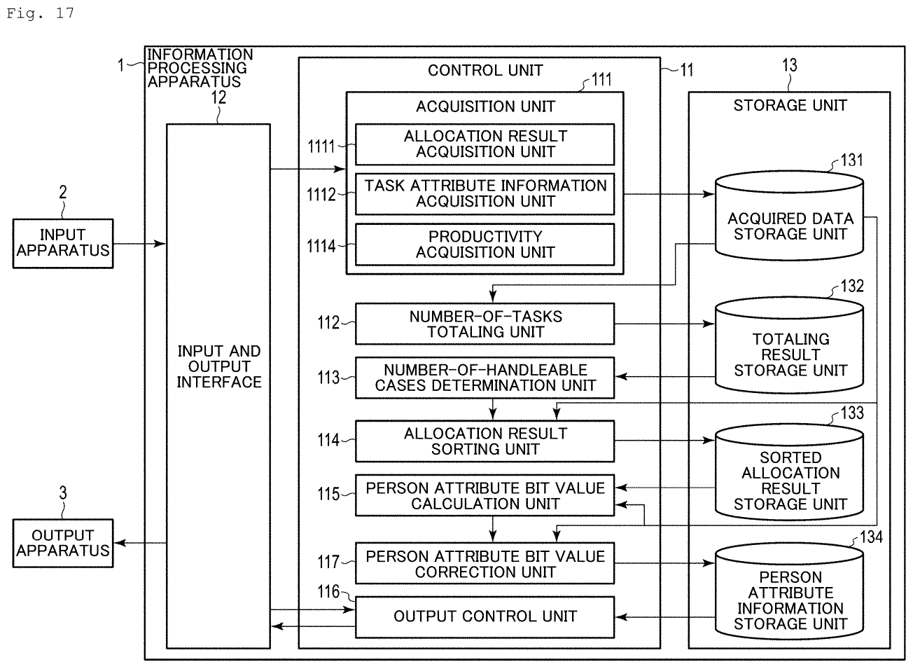

FIG. 17 is a block diagram illustrating a software configuration of the information processing apparatus 1 according to the fourth embodiment in association with the hardware configuration illustrated in FIG. 1.

A difference from the first embodiment is that the acquisition unit 111 includes a productivity acquisition unit 1114 and the control unit 11 includes a person attribute bit value correction unit 117.

The productivity acquisition unit 1114 acquires productivity information and reference productivity information in the past allocation results. The productivity information in the past allocation results is expressed by dividing the past performance amount for each person by time. Here, the performance amount may be anything as long as the performance amount can be expressed by a numerical value. For example, the performance amount is a production volume, a sales amount, a determination value by a drive recorder, or the like. The reference productivity information indicates a reference amount of productivity for each task. The reference productivity information may be minimum necessary productivity, or may be an average value of past productivity, for example. Further, the productivity acquisition unit 1114 stores the acquired productivity information and reference productivity information in the acquired data storage unit 131.

The person attribute bit value correction unit 117 corrects the person attribute information calculated by the person attribute bit value calculation unit 115 on the basis of the productivity information and the reference productivity information. A correction method will be described below.

### (Operation)

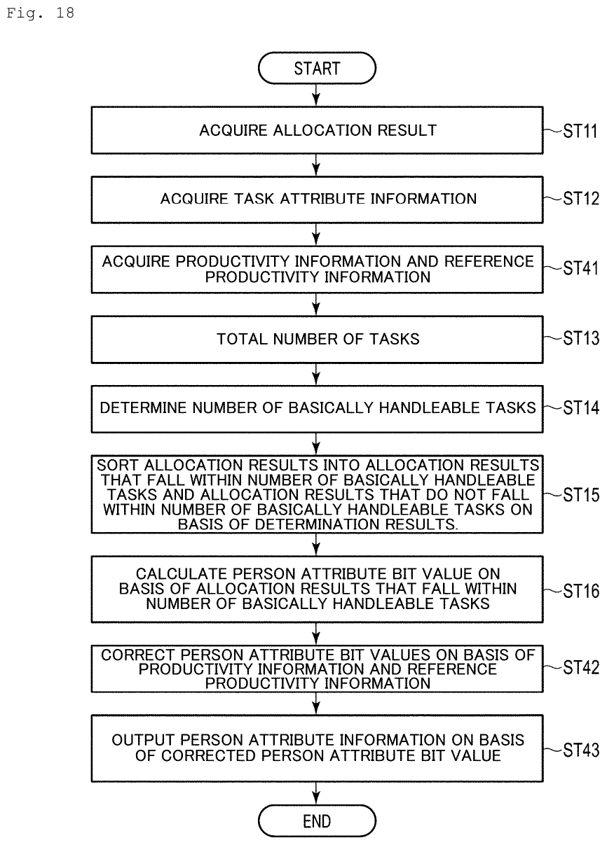

FIG. 18 is a flowchart illustrating an example of an information processing operation of the information processing apparatus 1. The control unit 11 of the information processing apparatus 1 reads and executes the program stored in the storage unit 13, thereby realizing the operation of this flowchart.

The operation starts when the user of the information processing apparatus 1 inputs predetermined information to the information processing apparatus 1.

Since steps ST11 to ST12 illustrated in FIG. 18 are the same as steps ST11 to ST12 described with reference to FIG. 3, re-descriptions thereof will be omitted.

The productivity acquisition unit 1114 acquires productivity information and reference productivity information in the past allocation results (step ST41). The productivity information is expressed by dividing the past performance amount for each person by time. Here, the performance amount may be anything as long as the performance amount can be expressed by a numerical value. The reference productivity information is the minimum necessary productivity. The productivity acquisition unit 1114 stores the acquired productivity and reference productivity in the acquired data storage unit 131.

Since steps ST13 to ST16 illustrated in FIG. 18 are the same as steps ST13 to ST16 described with reference to FIG. 3, re-descriptions thereof will be omitted.

In step ST16 in the fourth embodiment, the person attribute bit value calculation unit 115 does not store the calculated person attribute bit value in the person attribute information storage unit 134, but outputs the calculated person attribute bit value to the person attribute bit value correction unit 117.

The person attribute bit value correction unit 117 corrects the person attribute bit value on the basis of the productivity information and the reference productivity information in the past allocation results (step ST42). First, the person attribute bit value correction unit 117 acquires, from the acquired data storage unit 131, the allocation results, the productivity information in the past allocation results, and the reference productivity information. The person attribute bit value correction unit 117 compares the productivity included in the productivity information in the latest allocation result with the reference productivity included in the reference productivity information in order. The person attribute bit value correction unit 117 determines whether or not there is a task whose productivity in the allocation result is less than the reference productivity. For example, the person attribute bit value correction unit 117 determines that the productivity in the allocation result is lower than the reference productivity on a certain day. For example, depending on the productivity in the allocation result, the person attribute bit value correction unit 117, of course, may compare the productivity in the past allocation result with the reference productivity to determine a case in which the performance amount in the allocation result exceeds the reference productivity. For example, when the productivity is a percentage of mistakes and the reference productivity is a minimum allowable percentage of mistakes, the person attribute bit value calculation unit 115 compares the productivity with the reference productivity to determine a case in which the productivity exceeds the reference productivity.

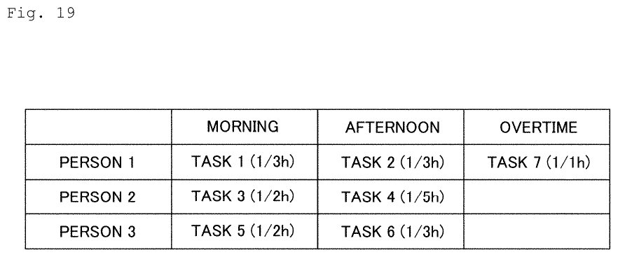

FIG. 19 is a diagram illustrating an example of productivity in allocation results on a certain day.

In the productivity in the past allocation result illustrated in FIG. 19, the performance amount is always 1 for simplification. The allocation result illustrated in FIG. 19 indicates that in task 1 and task 2 of person 1, performance amount 1 is obtained every 3 hours, that is, the task ended after 3 hours of work. Similarly, the allocation result indicates that in task 7, performance amount 1 is obtained every hour. The productivity illustrated in FIG. 19 is merely an example, and of course the present invention is not limited to the productivity.

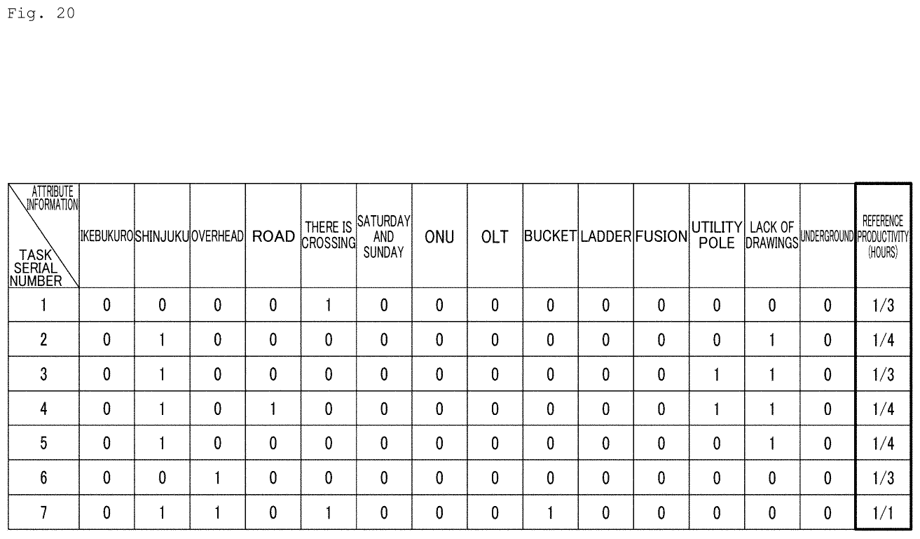

FIG. 20 is a diagram illustrating an example of reference productivity.

As illustrated in FIG. 20, the reference productivity may be, for example, the addition of the reference productivity to the task attribute information illustrated in FIG. 5. For example, as illustrated in FIG. 20, the reference productivity (work time) of task 1 is ⅓.

Comparing the productivity and reference performance in the past allocation results illustrated in FIGS. 19 and 20, the productivity in the past allocation results is less than the reference productivity when person 2 executes task 4.

Referring to the allocation result in FIG. 19, person 2 is doing task 3 and task 4. Therefore, the person attribute bit value correction unit 117 calculates the average value of the attribute information of tasks 3 and 4. The person attribute bit value correction unit 117 extracts attribute information with the smallest value among the attribute information with values exceeding zero. When there are a plurality of pieces of attribute information with the smallest value, the person attribute bit value correction unit 117 may extract all corresponding attribute pieces of information.

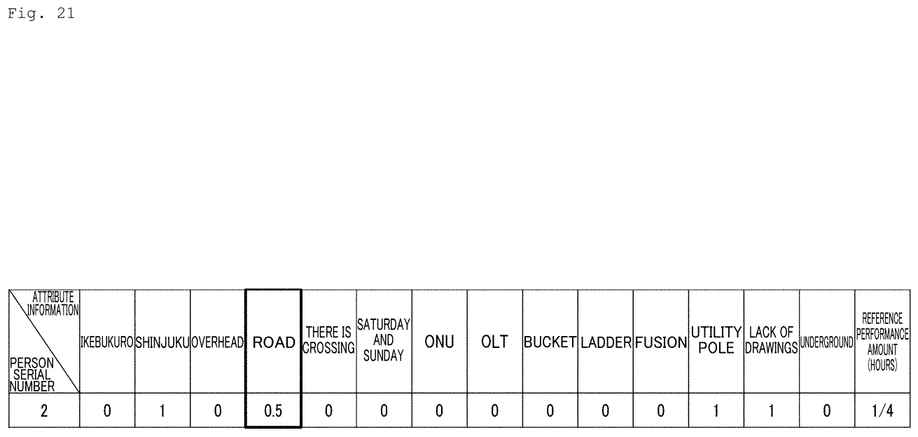

FIG. 21 is a diagram illustrating an example of an average value of person attribute bit values in person 2 acquired from person attribute bit value calculation unit 115.

Referring to FIG. 21, a road value of the attribute information is 0.5 and the smallest value. Therefore, assuming that attribute information that is allocated infrequently (inexperienced, or with infrequently used skill) is an item caused due to failing to satisfy the productivity, the person attribute bit value correction unit 117 determines that a value of the road thereof is corrected. The person attribute bit value correction unit 117 calculates an average value of the person (person 2) attribute bit in each attribute information again without using the sorted allocation result before a certain day (a day when the productivity in the past allocation result becomes less than the reference productivity). The person attribute bit value correction unit 117 stores the corrected person attribute bit value in the person attribute information storage unit 134.

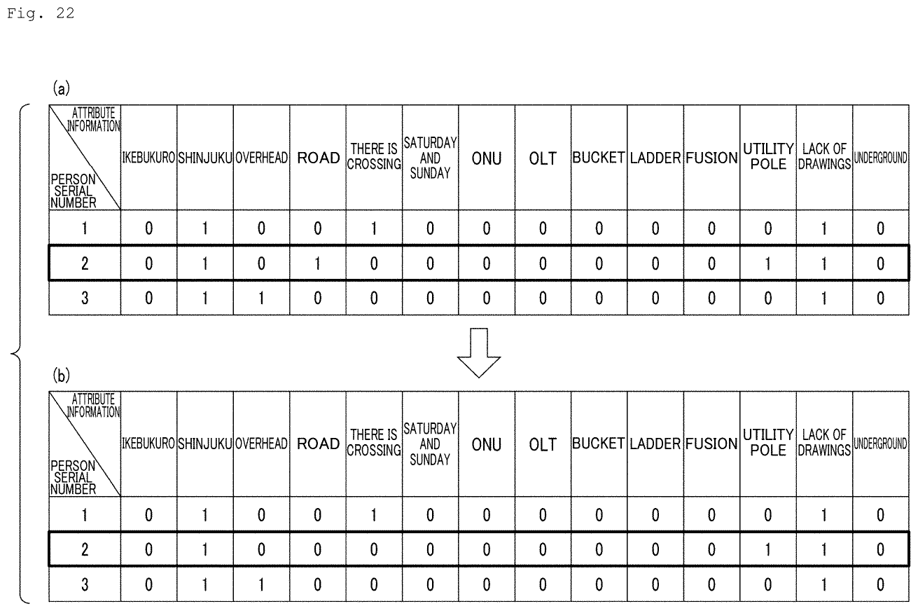

FIG. 22 is a diagram illustrating the person attribute bit value before correction and the person attribute bit value after correction.

FIG. 22(a) illustrates the person attribute bit value before correction, and FIG. 22(b) illustrates the person attribute bit value after correction. Referring to FIGS. 22(a) and 22(b), a bit value of attribute information of road construction of person 2 is corrected from 1 to 0. This makes it possible to calculate the person attribute bit value except for the allocation result that does not satisfy predetermined productivity.

The output control unit 116 outputs person attribute information on the basis of the corrected person attribute bit value (step ST43). The output control unit 116 acquires the person attribute bit value stored in the person attribute information storage unit 134. The output control unit 116 outputs person attribute information on the basis of the acquired person attribute bit value. As illustrated in FIG. 22(b), a person attribute bit value may simply be output, or only attribute information possessed by each person may be output. The output control unit 116 may output information indicating that the allocation result that does not fall within the number of basically handleable tasks has also been used.

Further, the fourth embodiment may be operated in combination with the second embodiment. For example, the control unit 11 may determine that the fourth embodiment is used when the allocation result input in step ST11 is equal to or greater than a predetermined threshold value (for example, 10 proposals), determine that the second embodiment is used when the allocation result is smaller than the predetermined threshold value, and execute the processing.

### (Effects)

According to the fourth embodiment, it is possible to determine the attribute information of the person without using the allocation results less than the predetermined productivity.

The accuracy of the proposal for allocating tasks to people created using the solver is improved by creating the attribute information of the human using only the allocation results that have room for work.

Further, since it is possible to update the person attribute information from the past allocation results, the person attribute information is always updated by creating the person attribute information for past allocation results including a directly previous allocation result.

Further, when an administrator or the like creates the person attribute information, the person attribute information is characterized as related to people, and thus, it becomes possible to not only reduce a work burden on the administrator or the like, but also reduce a psychological burden by automating the work.

### Fifth Embodiment

Even when people have the same skill, there are better and worse people. Further, even when a person performs the same skill multiple times, the person does not always handle the skill well. In the real world, allocation task is performed taking into consideration sensory things (for example, intuition) that cannot be expressed numerical values. Therefore, the information processing apparatus 1 of the fifth embodiment outputs the person attribute information in consideration of this sensory factor.

### (Configuration)

Since a hardware configuration of the information processing apparatus 1 according to the fifth embodiment is the same as that of the first embodiment, description thereof will be omitted.

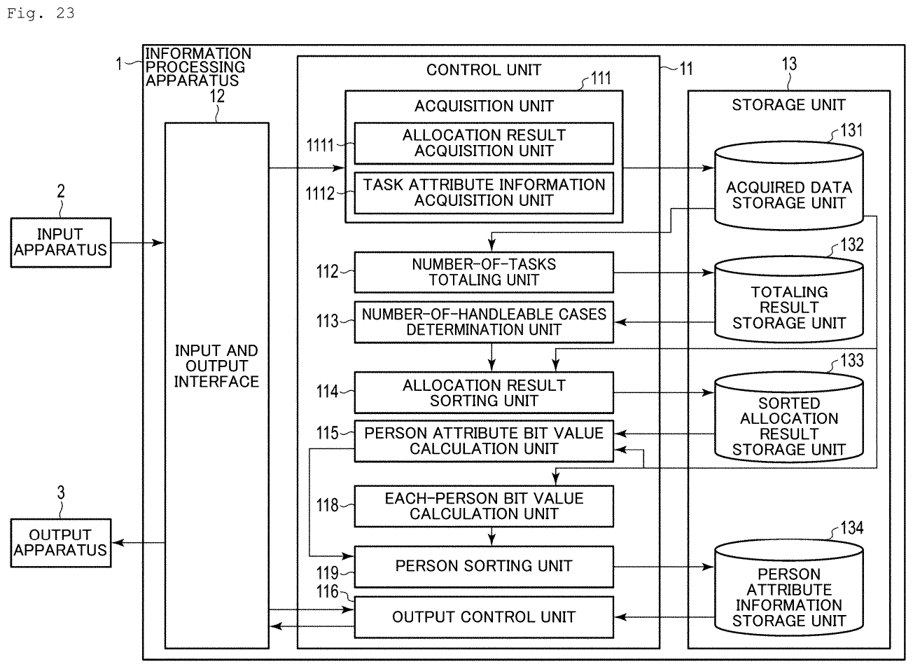

FIG. 23 is a block diagram illustrating a software configuration of the information processing apparatus 1 according to the fifth embodiment in association with the hardware configuration illustrated in FIG. 1.

A different point from the first embodiment is that the control unit 11 includes an each-person bit value calculation unit 118 and a person sorting unit 119.

The each-person bit value calculation unit 118 calculates an average of a total number of bit values of each person on the basis of the task attribute bit information and the allocation result. A specific calculation method will be described below. The each-person bit value calculation unit 118 outputs the calculation result to person sorting unit 119.

The person sorting unit 119 sorts people on the basis of the average of the total number of bit values of each person calculated by the each-person bit value calculation unit 118. For example, the person sorting unit 119 sorts people into reliable people, normal people, unreliable people, and the like. A specific sorting method will be described below.

### (Operation)

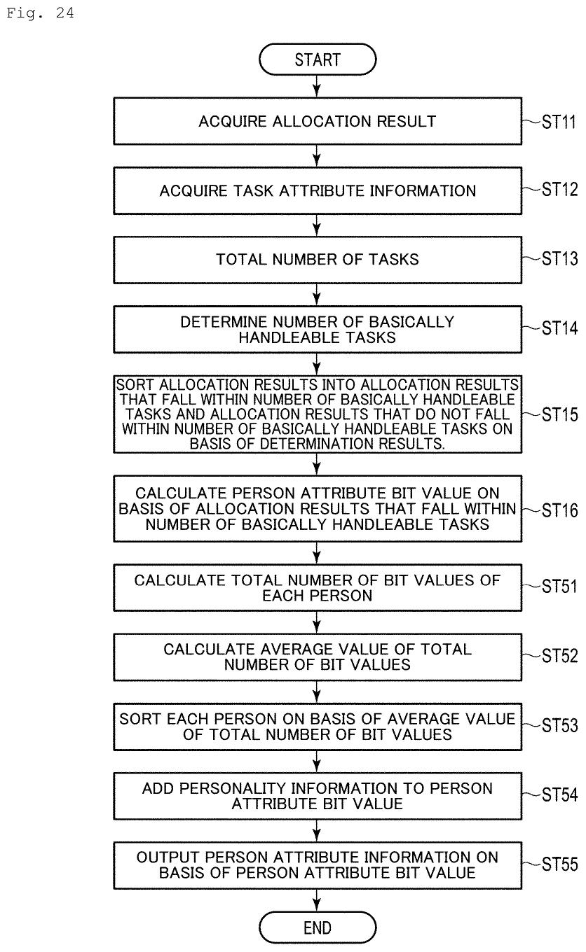

FIG. 24 is a flowchart illustrating an example of an information processing operation of the information processing apparatus 1. The control unit 11 of the information processing apparatus 1 reads and executes the program stored in the storage unit 13, thereby realizing the operation of this flowchart.

The operation starts when the user of the information processing apparatus 1 inputs predetermined information to the information processing apparatus 1.

Since steps ST11 to ST16 illustrated in FIG. 18 are the same as steps ST11 to ST16 described with reference to FIG. 3, re-descriptions thereof will be omitted.

In step ST16 in the third embodiment, the person attribute bit value calculation unit 115 does not store the calculated person attribute bit value in the person attribute information storage unit 134, but outputs the calculated person attribute bit value to the person attribute bit value correction unit 117.

The each-person bit value calculation unit 118 calculates the total number of bit values of each person on the basis of past allocation results and task attribute bit values (step ST51). The each-person bit value calculation unit 118 acquires the allocation results and the task attribute bit value from the acquired data storage unit 131. The total number of bit values of attribute information of tasks allocated by the allocation result is calculated for each person.

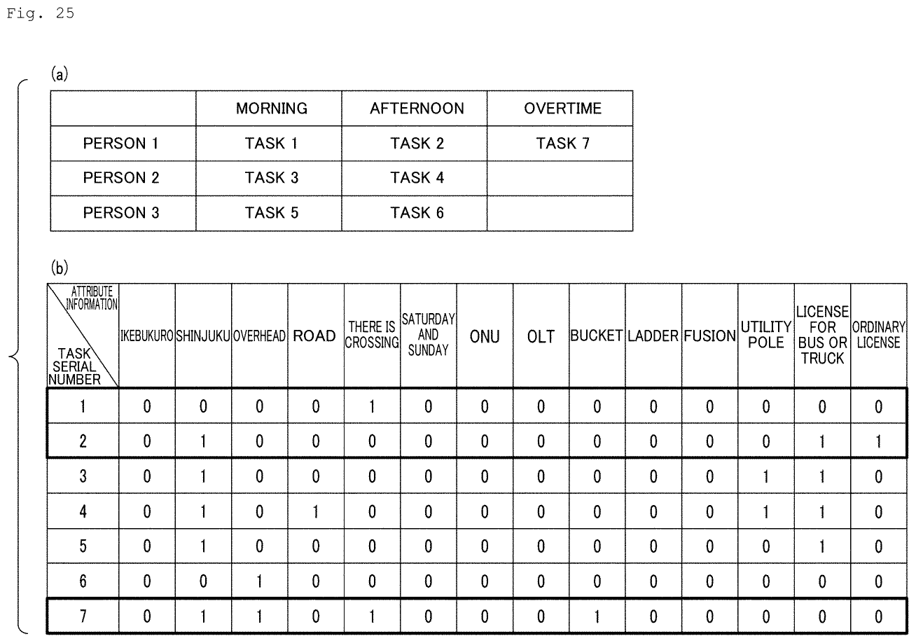

FIG. 25 is a diagram illustrating allocation results and task attribute bit values.

FIG. 25(a) illustrates allocation results, and FIG. 25(b) illustrates task attribute bit values. It is shown that person 1 illustrated in FIG. 25 has performed task 1, task 2, and task 7. Therefore, the each-person bit value calculation unit 118 calculates a sum of bit values of task 1, task 2, and task 7 illustrated in FIG. 25(b). Referring to FIG. 25(b), the total number of bit values for task 1 is 1, the total number of bit values for task 2 is 3, and the total number of bit values for task 7 is 4. Therefore, the total number of bit values in person 1 is 8. Similarly, the total number of bit values in person 2 is 7, and the total number of bit values in person 3 is 3. The each-person bit value calculation unit 118 calculates the total number of bit values of each person for each allocation result.

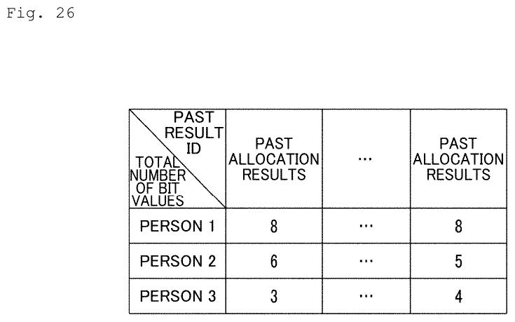

FIG. 26 is a diagram illustrating an example of the total number of bit values of each person calculated for each allocation result. In FIG. 26, a case in which there are 50 allocation results is illustrated, and a total number of people from allocation result 1 to allocation result 50 is illustrated.

The each-person bit value calculation unit 118 calculates an average value of the total number of bit values of each person on the basis of the past allocation results (step ST52). The each-person bit value calculation unit 118 divides the total number of bit values by the number of allocation results to which the total number of bit values is input, thereby calculating the average value of the total number of bit values. For example, the each-person bit value calculation unit 118 calculates the average value of the total number of bit values of person 1 illustrated in FIG. 26 as (8+ . . . +8)/50=7.5. Similarly, the each-person bit value calculation unit 118 calculates the average values of the total numbers of bit values of person 2 and person 3 as 6.0 and 3.5. The each-person bit value calculation unit 118 outputs the average value of the total number of bit values of each person to the person sorting unit 119.

The person sorting unit 119 sorts each person on the basis of the average value of the total number of bit values (step ST53). The person sorting unit 119 sorts each person into a predetermined number (the number of personalities). The number of personalities may be input by the user, or may be stored in the storage unit 13 of the information processing apparatus 1 in advance. For example, the acquisition unit 111 may acquire the number of personalities at the time of a user input in step ST11 or step ST12, and store the number in the acquired data storage unit 131. Further, usually, a person with a higher average value of the total number of bit values tends to be allocated to a relatively more difficult task. Therefore, a person with a great average value of the total number of bit values is assumed to be a reliable person, and a person with a small average value of the total number of bit values is assumed to be an unreliable person. For example, the person sorting unit 119 extracts a maximum value (for example, 7.5 in the example of FIG. 26) and a minimum value (for example, 3.5 in the example of FIG. 26) of the “average value of the total number of bit values” in each person from the average value of the total number of bit values of each person. Thereafter, the person sorting unit 119 sets the maximum value to 100%, expresses the minimum value as 0%, and calculates a ratio (%) of a position of the average value of the total number of bit values, which are targets. Here, the ratio of the position is calculated by [(average of total number of bit values of each person-minimum value)/(maximum value-minimum value)*100]. For example, the person sorting unit 119 sorts people in top 30% of the average of total number of bit values (the position ratio is 70% or more) into reliable people, people in the bottom 30% (the position ratio is 30% or less) into unreliable people, and people below the top 30% and above the bottom 30% into normal people. For example, the person sorting unit 119 sorts the person 1 described with reference to FIG. 26 as a reliable person, the person 2 as a normal person, and the person 3 as an unreliable person.

The person sorting unit 119 adds the sorting result to the person attribute bit value (step ST54). The person sorting unit 119 adds the result of sorting each person by sorting the personalities of the persons in step ST53 to the person attribute bit value. For example, the person sorting unit 119 sets the attribute information indicating that the person 1 is reliable to 1 when the person 1 is a reliable person. Similarly, the person sorting unit 119 sets normal attribute information to 1 when the person 2 is a normal person, and sets the attribute information indicating that the person 3 is unreliable to 1 when the person 3 is an unreliable person. The person sorting unit 119 adds this information to the person attribute bit value. The person sorting unit 119 stores the person attribute bit value to which the information on the sorting result has been added, in the person attribute information storage unit 134.

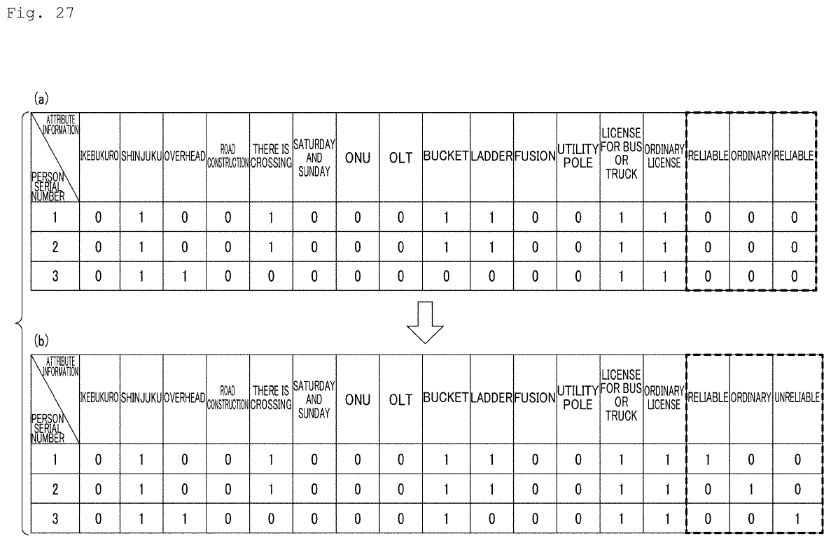

FIG. 27 illustrates an example in which a sorting result of each person has been added to the person attribute bit value. As illustrated in FIG. 27(a), the person sorting unit 119 adds attribute information such as reliable and usually unreliable. As illustrated in FIG. 27(b), the person sorting unit 119 adds information so that the bits indicating that people 1, 2, and 3 are reliable, and usually unreliable are set to 1.

The output control unit 116 outputs person attribute information on the basis of the corrected person attribute bit value (step ST55). The output control unit 116 acquires the person attribute bit value stored in the person attribute information storage unit 134. The output control unit 116 outputs person attribute information on the basis of the acquired person attribute bit value. As illustrated in FIG. 27(b), the person attribute bit value may be simply output, or only the attribute information possessed by each person may be output. The output control unit 116 may output information indicating that the allocation result that does not fall within the number of basically handleable tasks has also been used.

Further, the fifth embodiment may be operated in combination with the second embodiment. For example, the control unit 11 may determine that the fifth embodiment is used when the allocation result input in step ST11 is equal to or greater than a predetermined threshold value (for example, 10 proposals), determine that the second embodiment is used when the allocation result is smaller than the predetermined threshold value, and execute the processing.

### (Effects)

According to the fifth embodiment, it is possible to determine the person attribute information in consideration of the personalities of the persons.

The accuracy of the proposal for allocating tasks to people created using the solver is improved by creating the attribute information of the human using only the allocation results that have room for work.

Further, since it is possible to update the person attribute information from the past allocation results, the person attribute information is always updated by creating the person attribute information for past allocation results including a directly previous allocation result.

Further, when an administrator or the like creates the person attribute information, the person attribute information is characterized as related to people, and thus, it becomes possible to not only reduce a work burden on the administrator or the like, but also reduce a psychological burden by automating the work.

### OTHER EMBODIMENTS

Further, the present invention is not limited to the embodiment. For example, the present invention can be implemented by combining the third to fifth embodiments when necessary information is input.

Further, a scheme described in the embodiments can be stored as a program (software means) that can be executed by a computer in, for example, the storage medium such as a magnetic disk (a floppy (registered trademark) disk, hard disk, or the like), an optical disc (a CD-ROM, DVD, MO, or the like), a semiconductor memory (a ROM, RAM, flash memory, or the like), or transmitted and distributed via a communication medium. The program stored in the medium also includes a setting program for constructing, within the computer, software means (including not only execution programs but also tables and data structures) to be executed by the computer. A computer that realizes the present apparatus reads the program stored in the storage medium, constructs software means using the setting program in some cases, and executes the above-described processing by the software means controlling an operation. The storage medium referred to in this specification is not limited to a storage medium for distribution, and includes a storage medium such as a magnetic disk or a semiconductor memory provided in a computer or a device connected via a network.

In short, the present invention is not limited to the above-described embodiments, and can be modified in various ways without departing from the gist of the present invention at an implementation stage. Further, each embodiment may be implemented in combination as much as possible, and in this case, effects of the combination can be obtained. Further, inventions at various stages are included in the embodiments, and various inventions can be extracted by appropriately combining a plurality of disclosed constituent elements.

### REFERENCE SIGNS LIST

1: Information processing apparatus
2: Input apparatus
3: Output apparatus
11: Control unit
111: Acquisition unit
1111: Allocation result acquisition unit
1112: Task attribute information acquisition unit
1113: Forgetting curve acquisition unit
1114: Productivity acquisition unit
112: Number-of-tasks totaling unit
113: Number-of-handleable cases determination unit
114: Allocation result sorting unit
115: Person attribute bit value calculation unit
116: Output control unit
117: Person attribute bit value correction unit
118: Person bit value calculation unit
119: Person sorting unit
12: Input and output interface
13: Storage unit
131: Acquired data storage unit
132: Totaling result storage unit
133: Sorted allocation result storage unit
134: Person attribute information storage unit

1. An information processing apparatus comprising:
acquisition circuitry configured to acquire task attribute information including an allocation result indicating to which worker among a plurality of workers a past task has been allocated, and requirements necessary for the task:
number-of-handleable-cases determination circuitry configured to calculate the number of tasks that are handleable in each of the workers on the basis of the allocation result;
allocation result sorting circuitry configured to sort the allocation results on the basis of the number of handleable tasks; and
person attribute bit value calculation circuitry configured to calculate a person attribute bit value indicating what type of attribute each worker has, on the basis of the sorted allocation result and the acquired task attribute information.

2. The information processing apparatus according to claim 1, wherein:
the sorted allocation results include allocation results in which tasks allocated to the worker fall within the number of handleable tasks.

3. The information processing apparatus according to claim 1, wherein;
the sorted allocation results include allocation results in which tasks allocated to the worker fall within the number of handleable tasks, and allocation results in which tasks allocated to the worker exceed the number of handleable tasks.

4. The information processing apparatus according to claim 1, wherein:
the acquisition circuitry acquires forgetting curve information indicating how well the worker remembers the task according to the number of days that have elapsed since the worker has performed the task, and
the information processing apparatus further comprises person attribute bit value correction circuitry configured to correct the person attribute bit value on the basis of the forgetting curve information.

5. The information processing apparatus according to claim 1, wherein:
the acquisition circuitry acquires productivity information indicating productivity when the worker performs the task, and reference productivity information indicating the minimum productivity to be satisfied when the worker performs the task, and
the information processing apparatus further comprises person attribute bit value correction circuitry configured to correct the person attribute bit value on the basis of the productivity information and the reference productivity information.

6. The information processing apparatus according to claim 1, wherein:
the task attribute information is represented by a bit value, the bit value being 1 when the task attribute information is an attribute required for the task and 0 when the task attribute information is an attribute not required for the task,
the information processing apparatus further comprises:
each-person bit value calculation circuitry configured to calculate, for each worker, a total number of bit values of the attribute for the task allocated to the worker in the allocation result; and
person sorting circuitry configured to determine the personality of the worker on the basis of the calculated total number of bit values, and add the determined personality to the person attribute bit value.

7. An information processing method, comprising:
acquiring task attribute information including an allocation result indicating to which worker among a plurality of workers a past task has been allocated, and requirements necessary for the task;
calculating the number of tasks that are handleable in each of the plurality of workers on the basis of the allocation result;
sorting the allocation results on the basis of the number of handleable tasks; and
calculating a person attribute bit value indicating what type of attribute each worker has, on the basis of the sorted allocation result and the task attribute information.

8. A non-transitory computer readable medium storing an information processing program for causing a processor to perform the method of claim 1.
